(19) United States
(12) Patent Application Publication
(10) Pub. No.: US 2006/0252006 A1
(43) Pub. Date: Nov. 9, 2006

(54) Process for capture and removal of abrasive material for gas abrasive applications

(75) Inventors: Shaul Apelker, Coconut Creek, FL (US); Boaz Barry Groman, Boca Raton, FL (US)

Correspondence Address: BOAZ BARRY GROMAN, 7485 MALIBU CRESCENT, BOCA RATON, FL, 33433, US

(73) Assignee: GROMAN INC.

(21) Appl. No.: 11/121,628

(22) Filed: May 4, 2005

(51) Int. Cl. A61C 3/02; A61C 5/14

(52) U.S. Cl. 433/88; 433/136

(57) ABSTRACT

The present invention is a device for capturing abrasive particles expelled from air-abrasive apparatus and permitting their facile removal without the aid of a vacuum source, while facilitating an unobstructed view of the working area during use. One embodiment disclosed is a capture and removal device (1) of abrasive material (70) expelled by a gas abrasive dental apparatus (25) by generating a water curtain (50) from a water steam (45) delivered substantially tangential to concave surface (20) of a curved sheet (10). A method is disclosed for using water curtain (50) generated by capture and removal device (1) to capture and remove abrasive material (70) from the vicinity of an air-abrasive procedure. Certain other embodiments of the device can be used for non-dental applications.

### BACKGROUND OF THE INVENTION

1. Field of the Invention

This invention relates to air-abrasive devices, and more particularly to devices for collecting abrasive materials expelled by a gas-abrasive apparatus. The invention is particularly useful for dental applications.

2. Background of the Invention

The use of sandblasting devices to contact various surfaces has been known for some time. These devices are also known in the art as air-abrasive devices. Such devices vary in size and design depending on the particular utility desired.

One area where use of these devices has proved advantageous is in the etching or abrading of small surfaces. Devices designed for this use are typically hand held and capable of delivering fine streams of air-abrasive material through narrow nozzles.

A number of decades ago, the use of air-abrasive devices gained favor in the dental art. The methods developed were termed “air-abrasive techniques” and were designed to supplement the use of traditional dental drills to prepare a tooth for cavity repair, prophylaxis or other methods that required that a portion of the tooth be removed, roughened, or polished. The advantage of using air-abrasive techniques is that the dental patient experiences less trauma to the oral cavity due to the absence of perceptible pressure, vibration, noises created by the contact of a drill to tooth enamel, and heat created by frictional forces. This has resulted in reduced pain, apprehension, and fear by patients.

One disadvantage of the use of air-abrasive dental apparatus is that abrasive materials are dispersed into the oral cavity during use in a relatively uncontrolled fashion, can be inhaled by the patient, and are difficult to remove after a procedure is complete. Another disadvantage is that such particles can be dispersed into the air external of the oral cavity to create a hygiene problem. Airborne abrasive particles can carry pathogens and blood particles from the mouth and permit those pathogens and blood particles to contact otherwise uncontaminated surfaces.

Somewhat similar disadvantages exist with use of air-abrasive devices in other applications. Often it is desirable to prevent abrasive materials from contacting surfaces proximate to the target surface, from accumulating abrasive material on the target surface area, or from permitting fine abrasive particles from becoming airborne.

Several devices have been developed to affect the dispersion of abrasive particles within the oral cavity. Coston, U.S. Pat. No. 5,197,876 discloses a splatter guard for air polishing dental devices. The guard comprises a bell-shaped flexible cone that is attached to the end of an air-abrasive device and guides abrasive particles towards the surface being treated. Ho, U.S. Pat. No. 5,356,292 discloses a dental sandblasting confiner in the form of a flexible transparent cup. The nozzle of a sandblasting device can be inserted in large opening of the cup which forms a mold around the nozzle. The Ho device contains additional openings for access to a tooth surface and for discharging output. Lokken, U.S. Pat. No. 4,611,992 discloses an anti-splash device that can be attached to a dental tool. The device comprises an inverted U-shaped member with legs for attaching the device to the dental tool. Wright, U.S. Pat. No. 4,850,868 discloses a spray shield comprising a modified tube that can be attached to the end of a dental handpiece. The device is used to direct material dispensed from the handpiece in a controlled fashion so as to minimize the amount of airborne particles. Burns et al. U.S. Pat. No. 6,024,566 discloses a device for containing abrasive particles expelled from air-abrasive apparatus and permitting their facile removal without the aid of a vacuum source. This innovative device essentially operates as a vacuum cleaner bag but is challenging to apply due to the tight confines of the oral cavity and the large volume of air flow discharged by the air abrasive apparatus. Bembenek et al. U.S. Pat. No. 6,135,770 offers means of implementing high flow suction in the oral cavity using a containment chamber for suctioning the airborne abrasive particles thereby suctioning equal volume of air dispensed by the gas abrasive apparatus.

Since the standard dental chair equipment generally includes low vacuum suction called “Saliva Ejector” and High Velocity Vacuum source called “HVE”, most abrasive containment devices have been developed to utilize vacuum suction for abrasive material removal. Dentists however commonly dispense water for rinsing and air for drying tooth surfaces using standard dental chair equipment called “air-water syringe”. Over the years, dentists have developed a “water spray technique” to reduce dust buildup while administering air abrasive techniques. This water spray technique utilizes the air-water syringe to spray the abrasion site with water in order to capture the abrasive material around the abrasion site and some airborne particles.

Although the technique is simple to implement, it requires significant coordination between the dentist and the assistant to assure proper spraying of the abrasion site and suction of the captured abrasive material. Since the tooth site at the abrasion region is wet, the abrasive particles are slowed down prior to impacting the tooth surface thereby reducing the efficiency of the abrasion procedure. This may lead to an increase in the application time of the air-abrasive stream, further increasing the quantity of abrasive material being expelled. Additionally, since the target site is wet, significant back splashes are created when water trapped in the tooth crevasses are hit with the high velocity air stream of the air-abrasive apparatus. The increased propensity for splash backs and the extra level of assistant training are the drawback of the water spray technique. While the above cited inventions address one or more of the described disadvantages of air-abrasive systems, they are subject to several detrimental limitations. Although minimizing the amount of abrasive material released extra-orally, by guiding it into the oral-cavity for instance, has certain benefits, it is more preferable to collect and remove a substantial portion of released abrasive material. Many of the devices in the prior art guide the abrasive material to the suction source. As the abrasive material impacts the device at high speeds it bounces off the device and once again is air borne until it is suctioned away. As the abrasive material impacts the devices at high speeds the surface of the devices are scratched thereby reducing the clarity of the device and therefore making it more difficult to view the target surface during the procedure.

Other devices that do permit containment and removal of abrasive material are obtrusive and interfere with visualization of the surface to be abraded, making it difficult to perform precise dental procedures. Furthermore, those devices that do permit removal of abrasive material typically rely on an external high flow vacuum source to remove that material. Such a vacuum source adds additional expense and can also be intrusive.

### OBJECTS OF THE INVENTION

One object of the present invention is to provide a device for capturing a substantial portion of abrasive material expelled by a gas abrasive apparatus.

Another object of the present invention is to provide a device for capturing a substantial portion of abrasive material expelled by a gas abrasive apparatus that is capable of removing the captured abrasive material for easy collection.

Still another object of the present invention is to provide a simple inexpensive device for capturing and removing a substantial portion of abrasive material expelled by a gas abrasive apparatus without aid of a vacuum source.

Still another object of the present invention is to provide for a method to abrade a surface while capturing a substantial portion of abrasive material expelled from a gas apparatus.

Still another object of the present invention is to provide a process for making a device for capturing a substantial portion of material expelled by a gas abrasive apparatus.

Still another object of the present invention is to provide a process for making a device for capturing a substantial portion of material expelled by a gas abrasive apparatus that is capable of removing a substantial portion of expelled abrasive material for easy collection.

In addition, this invention teaches new innovative process for simple implementation of the water spray technique without the requirement for extra training and without the unpleasant splash back.

In addition, this invention utilizes a new innovative process to capture the abrasive material at first contact.

Other objects may be apparent to one of ordinary skill upon reading the following specification and claims.

### BRIEF DESCRIPTION OF THE SEVERAL VIEWS OF THE DRAWING

Various other objects, advantages, and features of the invention will become apparent to those skilled in the art from the following discussion taken in conjunction with the following drawings, where closely related figures have the same number but different alphabetic suffixes:

FIG. 1 is a perspective view of the device while in use in a dental application showing a relatively unobstructed view of the tooth surface to be abraded.

FIG. 2 is a perspective view of the preferred embodiment of the device showing the device supported by a handle.

FIG. 3 is a perspective view of the preferred embodiment of the handle supported device showing a modified curvature for capturing greater quantity of abrasive.

FIG. 4 is a perspective view of the preferred embodiment of the device showing the fluid delivery apparatus to be integral with the device handle.

FIG. 5 is a perspective view of the preferred embodiment of the device showing a fluid delivery nozzle configuration that delivers a plurality of fluid streams.

FIG. 6 is a perspective view of the preferred embodiment of the device showing a fluid delivery nozzle configuration that delivers a fluid curtain.

FIG. 7 is a perspective view of the preferred embodiment of the device showing a configuration with dual fluid nozzles and drain spots.

FIG. 8 is perspective views of the preferred embodiments of the device with an adjustable drainage guide and a fluid velocity deceleration flap.

FIG. 9 is perspective views of the preferred embodiment of the device with integral fluid and vacuum delivery sources.

FIG. 10 is perspective views of the preferred embodiments of the device with integral fluid and vacuum delivery sources using an enclosed circular curvature surface.

FIG. 11 is perspective views of the preferred embodiments of the device with integral fluid and vacuum delivery sources supporting a tangential vacuum suction port.

### REFERENCE NUMERALS IN DRAWINGS

1 abrasive capture and removal device

4 rubber dam

5 tooth

8 rubber dam clamps

10 curved sheet

15 first end wall

17 second end wall

20 concave surface

25 air-abrasive apparatus

28 air-abrasive nozzle

30 water delivery apparatus

35 water delivery tube

40 water delivery nozzle

45 water stream

50 water curtain

60 drain spot

70 abrasive material

75 handle

77 drainage port

78 drainage guide

80 vacuum suction apparatus

90 vacuum suction port

95 vacuum suction tube

99 decelerator flap

### DETAILED DESCRIPTION OF THE INVENTION

As required, detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

Reference is now made to the drawings, wherein like characteristics and features of the present invention shown in the various FIGURES are designated by the same reference numerals.

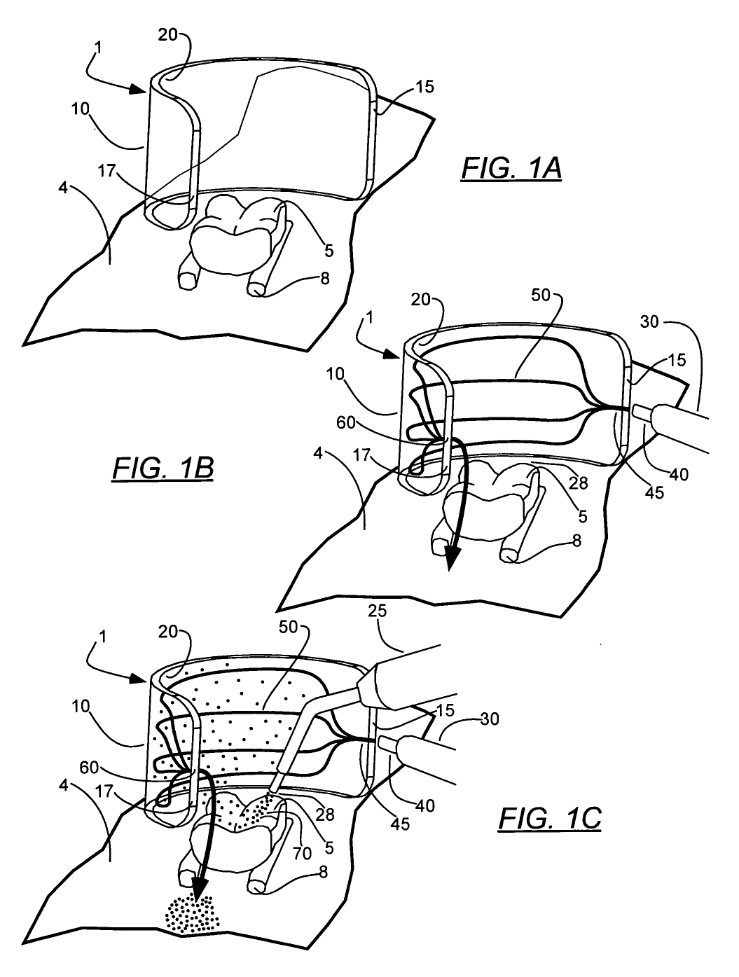

One aspect of this invention is a abrasive capture and removal device 1 for capturing and removing abrasive material expelled by a gas abrasive apparatus. Referring to FIG. 1, a rubber dam 4 supported by a rubber dam clamps 8 are shown to isolate a tooth surface 5. Although rubber dam 4 is shown for clarity of illustration it is not a requirement for use with abrasive capture and removal device 1. Rubber dams are well known in the art for use during dental procedures. Typically, rubber dams are comprised of rubber sheets which can stretch over one or more tooth surfaces and secured with clamps. The rubber dam is usually punctured as required to permit access to one or more tooth surfaces. An operator inserts clamps on either side of the tooth from the inside of the enclosure to secure the rubber dam in place. Devices used to clamp rubber dams in place are well known to those of ordinary skill in the dental art and include clamps, dental wedges, and cording material.

FIG. 1A shows a preferred embodiment of this aspect of the device of the present invention in the vicinity of a tooth surface 5 to be abraded. Abrasive capture and removal device 1 comprises a curved sheet 10 extending from first end wall 15 to second end wall 17; a concave surface 20 on the concave side of curved sheet 10; whereby concave surface 20 is preferably substantially smooth.

Referring to FIG. 1B, a water delivery apparatus 30 is positioned so water delivery nozzle 40 is substantially tangential to concave surface 20 of abrasive capture and removal device 1. A water stream 45 is delivered substantially tangential to concave surface 20 via water delivery nozzle 40. Water stream 45 flows onto concave surface 20 at high velocity. The curvature of curved sheet 10 forces the water to spread onto concave surface 20 as its momentum resists the change in direction. Water stream 45 spreads onto concave surface 20 until the water surface tension is able to restrain the radial forces applied on water stream 45. The curvature of curved sheet 10 forces water stream 45 to become a thin and wide water curtain 50 of equal flow rate. Water curtain 50 formed onto concave surface 20 is very thin providing for clear visibility of the tooth and abrasive nozzle 20 through curved sheet 10.

Water curtain 50 travels along concave surface 20 until its momentum diminishes and the water surface tension forces water curtain 50 back into a stream-like shape. A water drain spot 60 is formed on concave surface 20 where water curtain 50 is no longer able to sustain its forward momentum. The water drips at drain spot 60 into the oral cavity where it is easily removed by the dental saliva ejector or other means of evacuation.

Referring to FIG. 1C, a air-abrasive nozzle 28 of a air-abrasive apparatus 25 is positioned for the air-abrasive procedure opposite the concave region of abrasive capture and removal device 1. A abrasive material 70 is expelled by the gas-abrasive apparatus 25 via air-abrasive nozzle 28. Abrasive material 70 ricochets off the tooth surface and strikes into water curtain 50 as the air-abrasive procedure is performed. The surface tension of water curtain 50 captures abrasive material 70 and caries it along the concave surface 20 to drain spot 60, where the water and abrasive material 70 drip into the oral cavity for collection. The water-abrasive mixture forms sludge in the oral cavity which is easily collectable for removal via the dental saliva ejector or other means of evacuation. After a dental procedure is complete, abrasive capture and removal device 1 can be removed from the mouth in a controlled fashion and appropriately disposed of.

An important aspect of this invention is that water curtain 50 is made to resist splashing by the high velocity air stream from the gas abrasive apparatus. The water stream in its thin water curtain form is resistant to change in shape since it is balanced by its momentum and the water surface tension. Additionally, the surface tension of the thin water curtain is excellent at capturing and retaining the abrasive material impacting at high velocity.

Another aspect of this invention is that because water curtain 50 prevents abrasive material 70 from colliding with concave surface 20, the abrasive material 70 does not scratch concave surface 20. Therefore curved sheet 10 remains clear and undamaged for unobstructed view through the entire procedure.

Another aspect of this invention is that abrasive capture and removal device 1 is usable at any orientation with respect to the tooth surface, since the water and abrasive simply drain into the oral cavity for collection via standard dental suction tools.

Curved sheet 10 can be rigid, flexible, or a combination, but is preferably semi-flexible. Curved sheet 10 is preferably transparent so that the user can view the surface to be abraded. Suitable materials for the construction of sheet 20 include those materials used to manufacture plastic bags and tubing including, but not limited to, polyethylene, polyurethane, polyproplylene, vinyl, and the like. Others will be apparent to one of ordinary skill in the art. Vinyl is preferred due to its robust abrasion resistance.

It is understood that the terms air and gas as used herein can mean a single gas or a mixture of gasses. Examples include oxygen, nitrogen, argon, carbon dioxide, and atmospheric or industrial air. It is also understood that the term water as used herein can mean other fluids or a mixture of fluids which may be compatible with dental procedures or other applications.

Air-abrasive devices are well known to those of ordinary skill in the dental art. Fernwood et al., U.S. Pat. No. 4,941,298 and Hertz U.S. Pat. No. 5,839,946 disclose hand-held blasting devices for treating small surface areas. These devices are incorporated herein by reference. Generally the particle size of the abrasive particles will vary in accordance with the needs of the surface being abraded. Larger particles will cause a coarser abrasive pattern and smaller particles will cause a finer pattern. The size may range from about 500 microns to about 10 microns or less.

The device of the present invention can be of varying dimensions depending on the application. In the dental art, the dimensions are dictated by several factors including the number of teeth to be abraded and the size of the oral cavity, that of a child versus an adult, for instance. The dimensions can be symmetrical or non-symmetrical, depending on the particular application. A preferred embodiment of the device will have a curved surface diameter dimension ranging from about 0.25 to about 6 inches, with the width of curved sheet 10 ranging from 0.125 to 2 inches. A more preferred embodiment will have a curved surface diameter dimension range from about 0.5 inches to about 1.5 inches with the width of curved sheet 10 ranging from 0.25 to 0.6 inches.

The length of curved sheet 10 is dictated by several factors including the position of the abrasion procedure within the oral cavity, the orientation of the tooth surface to be abraded, the size of the air-abrasive apparatus and its nozzle length. The length of curved sheet 10 extends from first end wall 15 to second end wall 17 and ranges to form an open curvature to an enclosed curvature where first end wall 15 abuts second end wall 17. Preferably the diameter and length of curved sheet 10 are easily adjustable or easily formed to accommodate various requirements.

Another aspect of this invention is that curved sheet 10 provides an open region for easy access of the air-abrasive nozzle. Preferably, the open region in curved sheet 10 provides just sufficient space for comfortably placing the gas-abrasive nozzle such as disclosed in Fernwood. For gas abrasive instruments with long bendable nozzles such as the disposable instrument disclosed by Hertz, curved sheet 10 may be completely enclosed since the nozzle is sufficiently long to reach the tooth surface by passing through enclosed ‘ring shaped’ curved surface 10.

The diameter of water delivery nozzle 40 ranges from 0.100 to 0.001 inch. Preferably diameter of water delivery nozzle 40 ranges from 0.025 to 0.01 inch. Water pressure and flow rate regulators may be used to adjust the shape of water curtain 50 and the location of drain spot 60 by controlling the quantity and velocity of the water delivered onto concave surface 20. Elevated water temperatures may be provided to reduce the water surface tension and facilitate a thinner and wider water curtain 50.

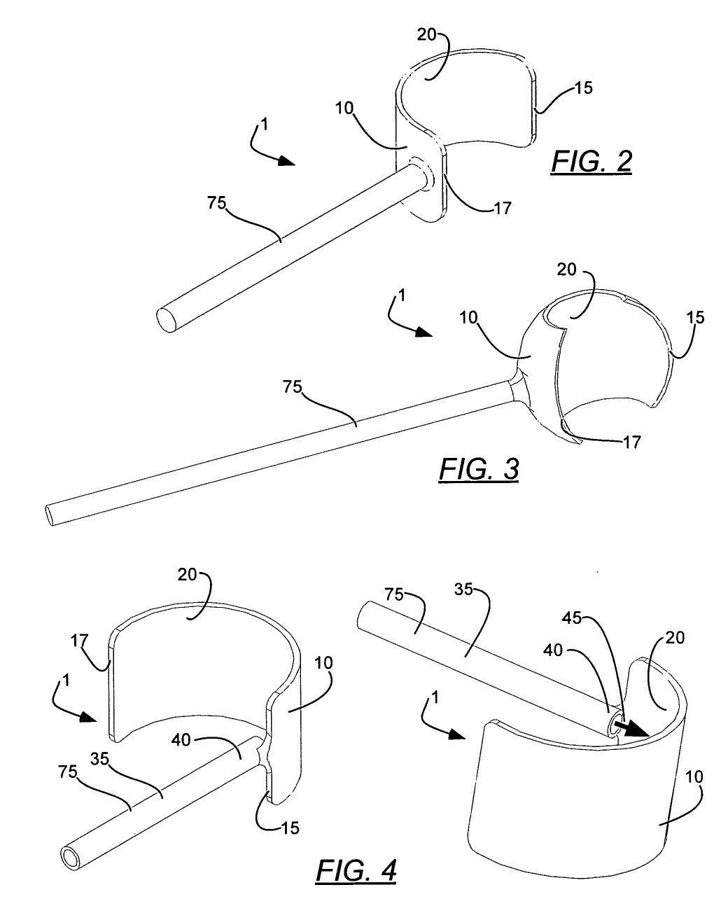

Referring to FIG. 2, a handle 75 is preferably attached to curved sheet 10. Handle 75 provides the user with ability to position and orient abrasive capture and removal device 1 within the oral cavity, while facilitating easy access and clear view of the working region.

Referring to FIG. 3, curved sheet 10 of abrasive capture and removal device 1 is also curved about its width dimension to gain more coverage about the tooth surface. This leads to increase in the quantity of captured abrasive material.

Referring to FIG. 4, a water delivery nozzle 40 is preferably contiguous with abrasive capture and removal device 1 and substantially tangential to concave surface 20. A water delivery tube 35 delivers waters stream 45 via water delivery nozzle 40. Integration of water delivery nozzle 40 eliminates the need for the user to aim the water nozzle 40 onto abrasive capture and removal device 1. Additionally, water delivery nozzle 40 and water delivery tube 35 in this embodiment also form handle 75.

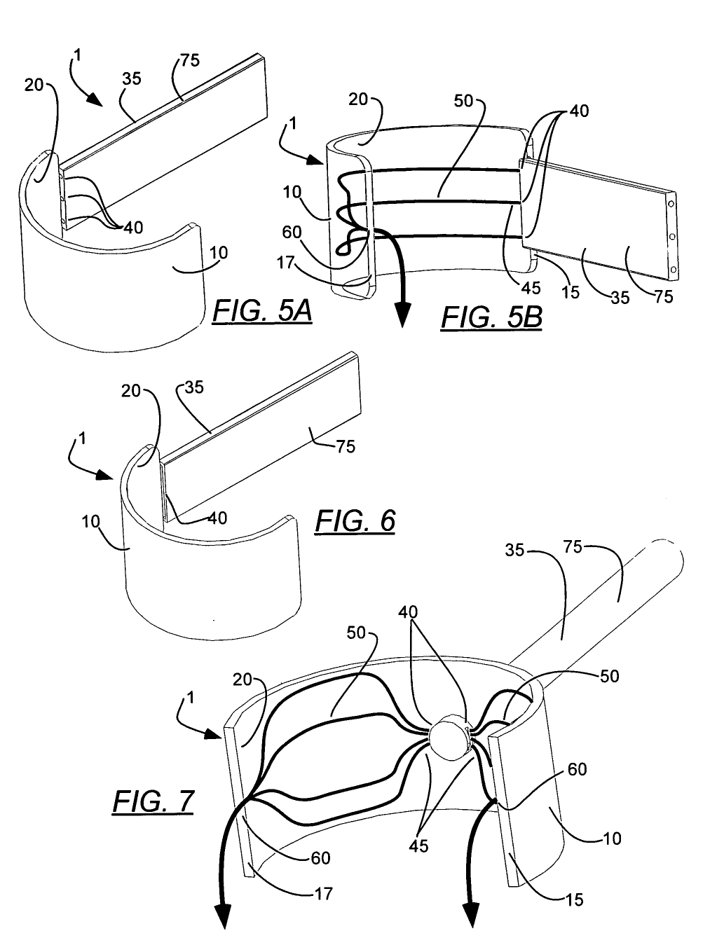

Referring to FIG. 5, a plurality of the water delivery nozzles 40 are provided substantially tangent to concave surface 20 to facilitate a more rapid development of water curtain 50. Referring to FIG. 6, the shape of water delivery nozzle 40 has a substantially narrow rectangular cross-section to facilitate the shape of water curtain 50 immediately onto concave surface 20. Development of water curtain 50 closer to water delivery nozzle 40 provides for a more efficient device, since water curtain 50 covers more area on concave surface 20 and therefore provides more abrasive capture surface. Referring to FIG. 7, additional efficiency and abrasive collection and removal capabilities are provided using dual water nozzles 40 onto concave surface 20. Dual water curtains 50 increase the capture surface area and abrasive material removal rate.

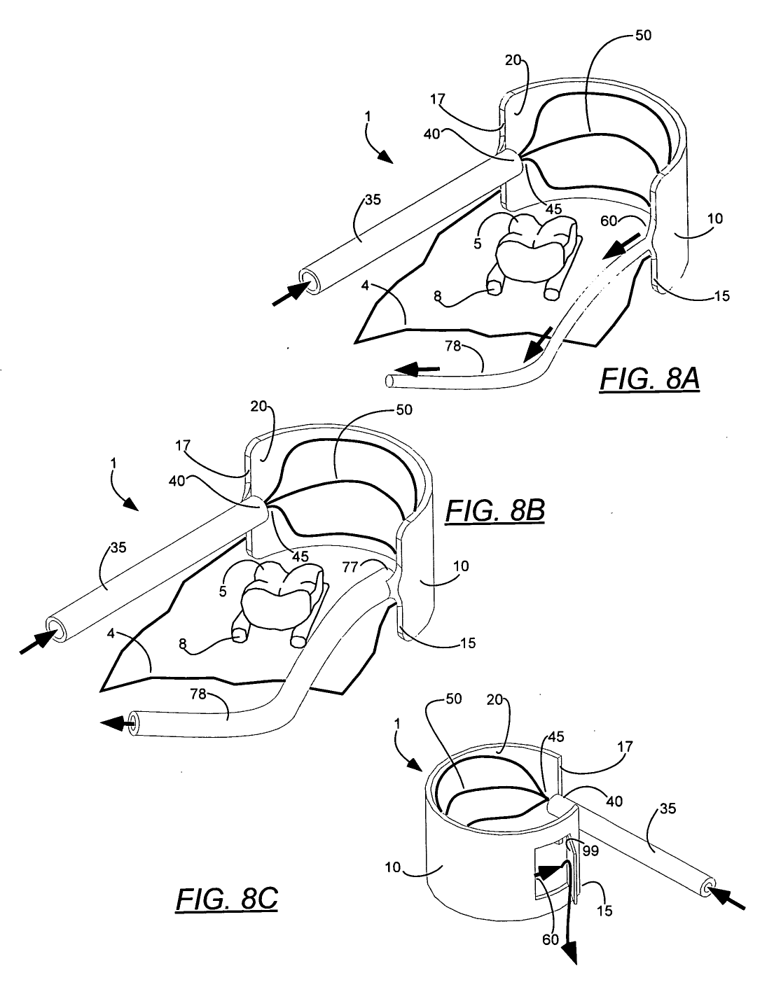

Referring to FIG. 8A, abrasive capture and removal device 1 supports a drainage guide 78 integral to curved sheet 10. Drainage guide 78 is preferably a flexible wire that facilitates the redirection of water stream 45 into a specific spot in the oral cavity. Drainage guide 78 extends from drain spot 60 into the oral cavity for easy collection of the water and abrasive material. The surface tension of the water permits water stream 45 to flow along drainage guide 78 and therefore be redirected to a convenient location within the oral cavity for removal. Referring to FIG. 8B, abrasive capture and removal device 1 supports drainage collection port 77 and a tube drainage guide 78. Drainage collection port 77 facilitates the collection of water stream 45 into the tube drainage guide 78. Drainage guide 78 is preferably a flexible tube and extends from drainage collection port 77 into the oral cavity for easy collection of the water and abrasive material. In both embodiments of FIG. 8A and FIG. 8B, drain guide 78 provides a target spot for placement of the suction evacuation apparatus. Referring to FIG. 8C, a deceleration flap 99 is disposed in curved sheet 10. Deceleration flap 99 is preferably integral to curved sheet 10 and oriented to deflect water stream 45 post drain spot 60 reducing its velocity for facile removal. Deceleration flap 99 provides a target spot for placement of the suction evacuation apparatus.

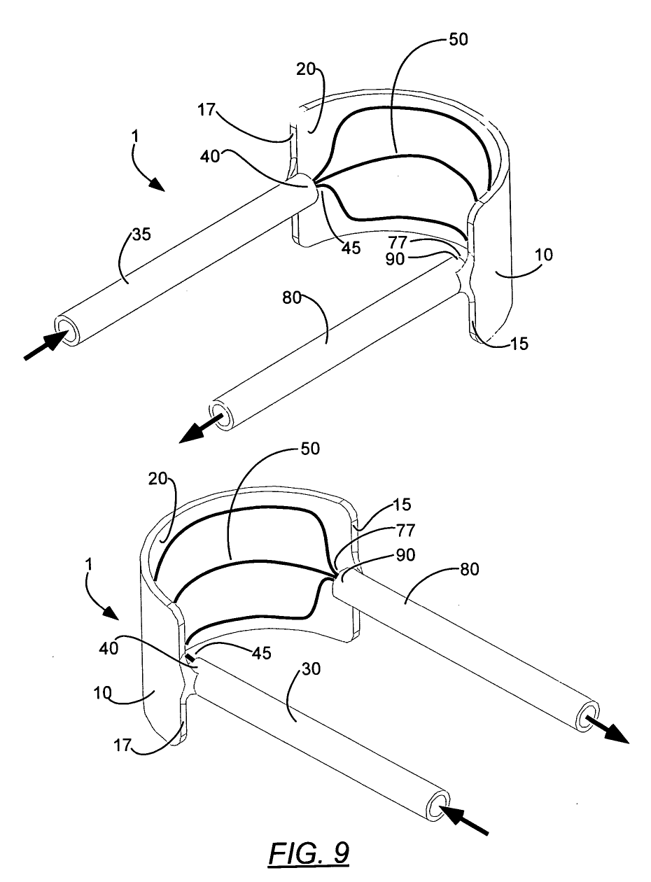

Referring to FIG. 9, a vacuum suction port 90 is provided at drainage collection port 77. A vacuum suction apparatus 80 is integrally engaged with vacuum suction port 90 to assist in the drainage of the water and abrasive material from concave surface 20. Integration of vacuum suction apparatus 80 eliminates the drain spot into the oral cavity, thereby freeing the operator from having to identify a drain spot and eliminating the need for additional assistance with the evacuation of the water and abrasive from the oral cavity.

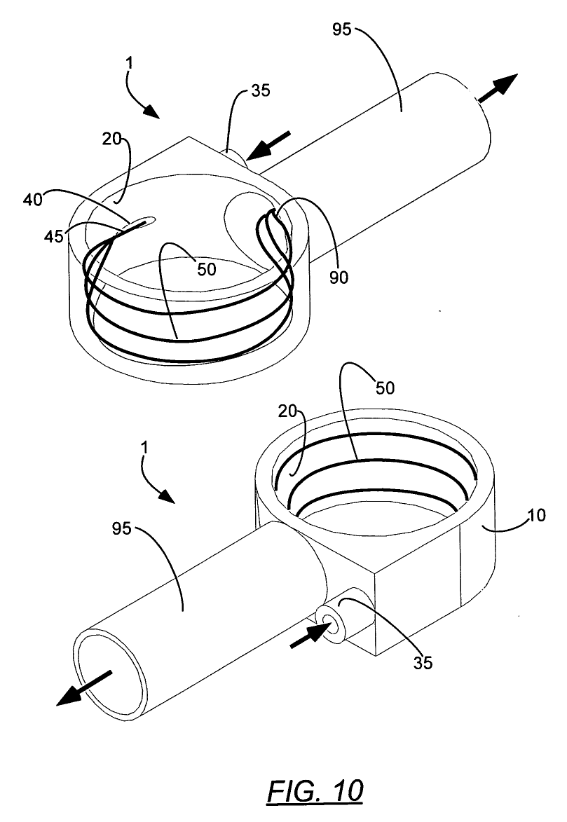

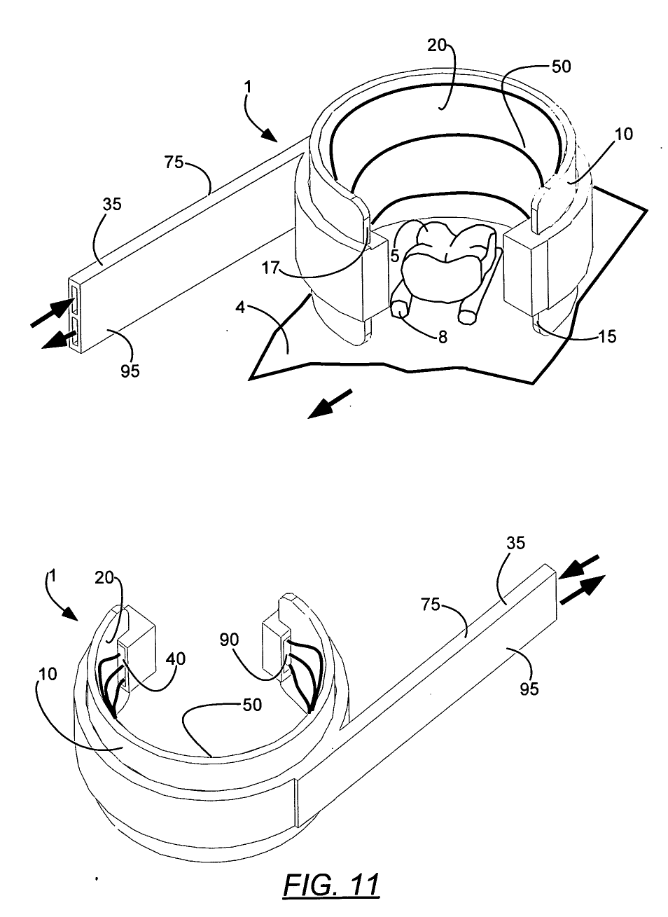

The preferred embodiment of FIG. 10 shows abrasive capture and removal device 1 with an enclosed circular curved sheet 10, although configurations with enclosed curve sheet 10 can also form ellipses, radial-spiral shapes, etc. A water delivery tube 35 and a vacuum suction tube 95 are integral to abrasive capture and removal device 1. This embodiment provides the collection and immediate removal of abrasive material 70 out of the oral cavity. This embodiment may be used in any location and orientation without concern of the drain spot location. This preferred embodiment is excellent for use with gas-abrasive apparatuses with long slender adjustable nozzles, such as Hertz discloses.

The preferred embodiment of FIG. 11 shows abrasive capture and removal device 1 with integral water delivery tube 35 and vacuum suction tube 95. This embodiment provides the collection and immediate removal of abrasive material 70 out of the oral cavity and optimizes the visibility and access to the tooth surface. This embodiment may also be used in any location and orientation without concern of the drain spot location. This embodiment is well suited for gas abrasive instruments with bulky handles and non-adjustable nozzles such as Fernwood discloses. Additionally, this configuration supports a vacuum suction port 90 which is tangential to concave surface 20. This tangential orientation of vacuum suction port 90 optimizes the collection of water curtain 50 and generates a strong air vortex in the direction water curtain 50 flows, further adding to the capture efficiency of abrasive capture and removal device 1. Preferably, the gap distance between first end wall 15 and second end wall 17 is adjustable to accommodate various gas-abrasive devices.

Another aspect of this invention is that abrasive capture and removal device 1 is usable at any orientation with respect to the tooth surface, and with the integration of the water delivery and suction apparatuses captured abrasive and water are completely removed by the device.

From the description above, the following advantages of the present invention become evident:
(a) Ability to form a controlled water stream in the shape of a water curtain which is able to capture abrasive material ricochet on first contact.
(b) Ability to immediately remove captured abrasive material from the vicinity of the air abrasive procedure.
(c) Ability to prevent the abrasive material from degrading the clarity of the device by scratching its surface.
(d) Ability to capture and remove abrasive material from the vicinity of the air-abrasive procedure by keeping the tooth surface dry.
(e) Ability to interface with a suction apparatus for completely removing the water and abrasive from the oral cavity.

While the invention has been described, disclosed, illustrated and shown in various terms or certain embodiments or modifications which it has assumed in practice, the scope of the invention is not intended to be, nor should it be deemed to be, limited thereby and such other modifications or embodiments as may be suggested by the teachings herein are particularly reserved especially as they fall within the breadth and scope of the claims here appended.

The device and method of the present invention can be used with other dental procedures—such as traditional hand drill or laser cutting—for capture and removal of generated debris. Preferred embodiments for non-dental applications will depend on the particular application. For example, the dimensions, composition, and configuration of the device can vary depending on the particular non-dental application, such as the etching of antique furniture or the sandblasting of stone surfaces.

Having completed the description of the apparatus in both its broad aspects and preferred embodiments, one of ordinary skill in the art may identify other aspects and embodiments of the invention that would be apparent and obvious to one upon reading the specification. Such aspects of the invention are meant to be included within the scope of this disclosure and claims. All references to U.S. patents in this application should be interpreted to incorporate by reference the disclosure of each patent herein.

### SUMMARY OF THE INVENTION

The present invention accomplishes the above-stated objectives, as well as others, as may be determined by a fair reading and interpretation of the entire specification.

Accordingly, the reader will see that the present invention is a device for capturing abrasive particles expelled from a gas abrasive apparatus and permitting their facile removal by generating a water curtain from a water steam delivered substantially tangential to the concave surface of a curved sheet.

Furthermore, the present invention has the additional advantages in that
it collects the abrasive material at first contact with the water curtain.
immediately after the abrasive particles contact the water curtain they are removed from the vicinity of the air-abrasive procedure.
the water curtain protects the device from being scratched by the abrasive material.
it provides the user with unobstructed view of the working area during use.
it enhances the effectiveness of air abrasive techniques by providing the benefits of the dental water spray technique for abrasive material capture while keeping the tooth surface dry thereby
   1) eliminating the unpleasant water splash back,
   2) and enhancing the impact effectiveness of the air abrasive apparatus.
it provides the benefits of the water spray technique for air abrasive procedures without the requirement for additional training by the dentist and/or assistant.

Another aspect of the present invention is a method for abrading a surface, particularly a tooth surface and collecting abrasive material. The method comprises abrading the surface with a gas abrasive apparatus in combination with a device (particularly as described above) and a water source for capturing and removing abrasive material expelled by the gas abrasive apparatus.

Another aspect of the present invention is a method for abrading a tooth surface, capturing and removing the abrasive material. The method comprises abrading the surface with a gas abrasive apparatus in combination with a device (particularly as described above), a water source for capturing and removing abrasive material expelled by the gas abrasive apparatus, and a suction source for removing the water and abrasive from the oral cavity.

Still another aspect of the present invention is a process for making a device for collecting and removing abrasive material expelled by a gas abrasive apparatus. The process comprises a water steam delivered substantially tangential to a concave surface of a curved sheet to form a water curtain which captures and removes the abrasive material from the vicinity of the air-abrasive procedure.

Still another aspect of the present invention is a process for making a device for collecting and removing abrasive material expelled by a gas abrasive apparatus. The process comprises a water steam delivered substantially tangential to concave surface of a curved sheet to form a water curtain which captures and removes the abrasive material into a suction source for removal of the water-abrasive mixture out of the oral cavity.

Other aspects of the invention will be apparent to one of ordinary skill in the art upon reading the following specification and appended claims. Thus the scope of the invention should be determined by the appended claims and their legal equivalents, rather than by the examples given.

What I claim as my invention is:

1. A device for capturing and removing abrasive material expelled by a gas abrasive apparatus, comprising:
a curved sheet extending from first end wall to second end wall;
a substantially smooth concave surface;
a fluid nozzle delivering a fluid stream substantially tangential to said concave surface;
a fluid curtain produced onto the concave surface proximally to said fluid nozzle and extending to a drain spot;
wherein said fluid curtain provides means for capturing airborne particulates upon contact and removal to said drain spot.

2. The apparatus, according to claim 1, wherein:
a handle is attached to said curved sheet;
wherein said handle provides means for holding, positioning and orienting the curved sheet.

3. The apparatus, according to claim 1, wherein:
said fluid nozzle is integral to said curved sheet.

4. The apparatus, according to claim 3, wherein:
said fluid nozzle provides means for holding, positioning and orienting the curved sheet.

5. The apparatus, according to claim 1, wherein:
a plurality of fluid nozzles deliver fluid streams substantially tangential to said concave surface.

6. The apparatus, according to claim 1, wherein:
said fluid nozzle supports the shape of an elongated rectangle;
wherein delivering said fluid stream onto concave surface substantially in the shape of said fluid curtain.

7. The apparatus, according to claim 1, wherein:
said first end wall abuts said second end wall;
wherein enclosing the curved sheet.

8. The apparatus, according to claim 1, wherein:
A drainage guide extends proximally from said drain spot into the oral cavity;
wherein said drainage guide provides means for redirecting said fluid stream.

9. The apparatus, according to claim 1, wherein:
a drainage port is disposed proximally to said drain spot on said curved sheet.

10. The apparatus, according to claim 9, wherein:
a drainage tube is disposed on said drainage port.

11. The apparatus, according to claim 10, wherein:
a suction source is attached to said drainage tube.

12. The apparatus, according to claim 9, wherein:
a suction source is disposes at said drainage port.

13. The apparatus, according to claim 1, wherein:
a suction source is attached to said curved sheet;
wherein said suction source provides means for evacuation of said fluid stream.

14. The apparatus, according to claim 13, wherein:
said suction source provides means for holding, positioning and orienting the curved sheet.

15. The apparatus, according to claim 1, wherein:
a vacuum suction port is disposed on said curved sheet.

16. The apparatus, according to claim 15, wherein:
said vacuum suction port is substantially tangential to the concave surface.

17. The apparatus, according to claim 15, wherein:
a suction source disposed at said suction port provides means for evacuation of said fluid stream.

18. The apparatus, according to claim 15, wherein:
a vacuum suction tube is disposed at said vacuum suction port.

19. The apparatus, according to claim 18, wherein:
a suction source disposed at said suction tube provides means for evacuation of said fluid stream.

20. The apparatus, according to claim 1, wherein:
a deceleration flap is disposed on said curved sheet;
wherein said deceleration flap deflects said fluid stream post said drain spot to reduce its velocity.

21. A method for abrading a surface, capturing and removing abrasive material, which method comprises:
a device for capturing and removing abrasive material expelled by a gas abrasive apparatus which device comprises:
a curved sheet;
a substantially smooth concave surface;
a fluid nozzle delivering a fluid stream substantially tangential to said concave surface of said device for capturing and removing abrasive material;
a fluid curtain formed on said concave surface by said fluid stream;
positioning the device for capturing abrasive material over the surface to be abraded;
a gas abrasive apparatus for abrading the surface;
abrading the surface with the gas abrasive apparatus in combination with the device for capturing abrasive material expelled by the gas abrasive apparatus;
wherein said water curtain removes the captured abrasive material.
